(19) United States
(12) Patent Application Publication
(10) Pub. No.: US 2025/0257248 A1
(43) Pub. Date: Aug. 14, 2025

(54) CURABLE ADHESIVE AND ARTICLES FOR BONDING PAVEMENT AND CONCRETE

(71) Applicant: 3M INNOVATIVE PROPERTIES COMPANY, St. Paul, MN (US)

(72) Inventors: Chelsea M. Lambert, River Falls, WI (US); Jonathan E. Janoski, Woodburry, MN (US); Todd D. Jones, St. Paul, MN (US); Andrew Satrijo, St. Paul, MN (US); Matthew J. Bruzek, Woodbury, MN (US); Susannah C. Clear, Hastings, MN (US); Gregg A. Patnode, Woodbury, MN (US)

(21) Appl. No.: 18/851,213

(22) PCT Filed: Jun. 7, 2023
(86) PCT No.: PCT/IB2023/055875

§ 371 Date: Sep. 26, 2024

Related U.S. Application Data
(60) Provisional application No. 63/356,592, filed on Jun. 29, 2022.

(51) Int. Cl. C09J 7/38; C09J 153/00; C09J 163/00; C09J 171/12

(52) U.S. Cl. CPC C09J 7/387; C09J 153/005; C09J 163/00; C09J 171/12; C09J 2301/302; C09J 2301/408; C09J 2301/414; C09J 2301/416; C09J 2453/00; C09J 2463/00; C09J 2467/006; C09J 2471/00

(57) ABSTRACT

Adhesive articles a methods of use are described comprising a layer of a curable adhesive composition that comprises 20 wt. % to 60 wt. % of a thermoplastic block copolymer; 5 wt. % to 60 wt. % of an epoxy resin; and 1 wt. % to 60 wt. % of a polyol; and inorganic particles disposed on a major surface of the article. In some embodiments, the block copolymer is an acrylic block copolymer. Typical inorganic particles include reflective (e.g. retroreflective) particles, traction particles (e.g. skid-resistance particles, anti-slip particles), and combinations thereof.

### SUMMARY

Although various adhesive compositions and articles have been described, industry would find advantage in adhesive compositions that exhibit good adhesion to concrete and pavement and that are suitable for outdoor use.

In one embodiment, an adhesive article is described comprising a layer of a curable adhesive composition that comprises 20 wt. % to 60 wt. % of a thermoplastic block copolymer; 5 wt. % to 60 wt. % of an epoxy resin; and 1 wt. % to 60 wt. % of a polyol; and inorganic particles disposed on a major surface of the article. In some embodiments, the block copolymer is an acrylic block copolymer.

Representative inorganic particles include reflective particles, traction particles (e.g. skid-resistance particles, anti-slip particles), and combinations thereof. In some favored embodiments, the reflective particles are reflective pigment particles or retroreflective elements selected from a) glass or ceramic beads or b) a core particle comprising the beads at least partially embedded in a core. In some embodiments, the adhesive article is a pavement marking tape.

In another embodiment, a method of use is described comprising providing an adhesive article as described herein and adhering the curable adhesive composition to a pavement surface or concrete.

In another embodiment, a method of use is described comprising applying the curable adhesive composition as described herein to a pavement surface or concrete; and applying inorganic particles to the curable adhesive composition. In both embodiments, the method may further comprise applying a primer to the pavement surface or concrete prior to adhering the curable adhesive composition or applying the curable adhesive composition.

The articles and methods described herein are particularly advantageous for pavement surfaces at an intersection for motor vehicles.

### BRIEF DESCRIPTION OF THE DRAWING

FIG. 1 is a cross-sectional view of an illustrative retroreflective element;

FIG. 2 is a perspective view of an illustrative pavement marking; and

FIG. 3 is a cross-sectional view of an illustrative pavement marking tape.

### CURABLE ADHESIVE COMPOSITION

### Thermoplastic Polymer

The curable adhesive comprises a thermoplastic polymer. Thermoplastic polymers can change from a solid to a liquid with heat rather than a solvent. Thus, the curable adhesive composition can advantageously be substantially solvent-free (i.e. less than 1, 0.5 or 0.1 wt. % of organic solvent).

When compounded with epoxy resin and polyol, the thermoplastic polymer can exhibit good adhesion to pavement surfaces and concrete in the absence of heat.

In typical embodiments, the thermoplastic polymer comprises one or more block copolymers, comprising at least two A block polymeric units and at least one B block polymeric unit (i.e., at least two A block polymeric units are each covalently bonded to at least one B block polymeric unit). The A block tends to be more rigid than the B block (i.e., the A block has a higher glass transition temperature than the B block). The A block is also referred to herein as a “hard block” and the B block is also referred to herein as a “soft block.” In some embodiments, the thermoplastic block copolymer comprises acrylic block copolymer(s). In this embodiment, the A block is derived from a first (meth)acrylate monomer and the B block is derived from a second (meth)acrylate monomer. Acrylic block copolymers are differentiated from other acrylic copolymers in that they exhibit phase segregation at temperatures lower than the glass transition temperature of the end blocks. This leads to elastomeric properties below that temperature and the ability to compound solvent-free above that temperature. A consequence of this behavior may be superior roll stability and static shear performance of materials compounded with acrylic block copolymers compared to their random acrylic copolymer counterparts. In some embodiments, the (e.g. acrylic) block copolymer comprises an A-B-A triblock copolymers.

In some embodiments, the (e.g. acrylic) block copolymer comprises at least 7, 8, 9 or 10 wt. % and no greater than 51 wt. % of hard blocks (“A block”) and 49 wt. % to 93 wt. % of a soft block (“B block”) based on the weight of the block copolymer. In some embodiments, the (e.g. acrylic) block copolymer comprises at least 15 or 20 wt. % of hard block. In some embodiments, the (e.g. acrylic) block copolymer comprises no greater than 45, 40, or 25 wt. % of hard block. Higher amounts of the A block tend to increase the stiffness or modulus of the copolymer, which can be used to optimize properties of the composition such as the mechanical strength and modulus.

In some preferred embodiments, one or both of the blocks is non-reactive during the UV-activated epoxy reaction (e.g. one or both blocks does not contain pendant epoxy or hydroxyl functionality). In some preferred embodiments, the hard block comprises polymethyl methacrylate. In some preferred embodiments, the soft block comprises polybutyl acrylate. Methods of preparing acrylic block copolymers are known to those of skill in the art and are described, for example, in U.S. Pat. No. 6,806,320 (Everaerts et al.). Acrylic block copolymers useful in embodiments of the present disclosure are also commercially available, for example, from Kuraray CO., Tokyo, Japan under the trade designation “KURARITY.”

In some embodiments, the (e.g. acrylic) block copolymer has a weight average molecular weight of at least 30, 40 or 50,000 g/mole as measured with Gel Permeation Chromatography using the test method described in the examples. The (e.g. acrylic) block copolymer typically has a weight average molecular weight no greater than 200,000; 175,000; 150,000; 125,000 or 100,000 g/mole. In some embodiments, the (e.g. acrylic) block copolymer has a weight average molecular weight of at least 60,000; 70,000; 80,000; 90,000 or 100,000 g/mole. In some embodiments, the (e.g. acrylic) block copolymer has a weight average molecular weight of no greater than 100,000; 90,000; 80,000; 70,000; or 60,000 g/mole. The curable adhesive composition may comprise a single (e.g. acrylic) block copolymer or a blend of a higher and lower molecular weight copolymers.

Melt flow rate (MFR) is another way to express molecular weight (as determined with ISO 1133). In some embodiments, the (e.g. acrylic) block copolymer has a MFR of at least 2, 3, or 4 g/10 minutes at a temperature of 190° C. and weight of 2.16 kg. In some embodiments, the (e.g. acrylic) block copolymer has a MFR of no greater than 60, 50, 40, or 30 g/10 minutes at a temperature of 190° C. and weight of 2.16 kg. In some embodiments, the MFR of the (e.g. acrylic) block copolymer is at least 5, 10, 15, 20, 25, or 30 g/10 minutes at a temperature of 190° C. and weight of 2.16 kg. In some embodiments, the MFR of the (e.g. acrylic) block copolymer is less than 30, 25, 20, 15, 10, or 5 g/10 min at a temperature of 190° C. and weight of 2.16 kg.

In some embodiments, the curable adhesive composition comprises at least 20, 25, 30, 35, or 40 wt. % of thermoplastic block copolymer, based on the total weight of thermoplastic block copolymer, epoxy resin and polyol. The amount of thermoplastic polymer is typically no greater than 60, 55, or 50 wt. %.

### Epoxy Resin

Curable adhesive compositions include at least 5, 10, 15 or 20 wt. % and no greater than 60, 55, 50, or 45 wt. % of an epoxy resin, based on the total amount of thermoplastic block copolymer, epoxy and polyol. A variety of commercially available epoxy resins can be utilized in curable compositions of the present disclosure. Typically, useful epoxy resins may have an epoxy equivalent weight of from 150 to 250.

In some embodiments, the epoxy resin may comprise a first epoxy resin and a second epoxy resin combined in a ratio of 0.5:1.5, optionally 0.75:1.25, or optionally 1:1. In some embodiments, the second epoxy resin has an epoxy equivalent weight of from about 500 to about 600.

In some preferred embodiments, the epoxy resin comprises a bisphenol A derived epoxy resin. Examples of such preferred epoxy resins include, without limitation, a difunctional bisphenol A/epichlorohydrin derived epoxy resin, commercially available under the trade designation “EPON 828” from Dow Inc., Midland, Michigan, and a difunctional bisphenol A/epichlorohydrin derived epoxy resin, commercially available under the trade designation “EPON 1001F” from Dow Inc., Midland, Michigan.

### Polyol

Curable adhesive compositions described herein comprise a polyol. The term polyol refers to a material having at least two hydroxyl groups and a molecular weight of at least 500, 1000, 1500, or 2000 g/mol and no greater than 14,000 g/mol. Curable adhesive compositions typically comprise at least 1, 2, 3, 4, or 5 wt. % of a polyol and no greater than to 60, 55, or 50 wt. %, based on the total amount of thermoplastic block copolymer, epoxy, and polyol. In some embodiments, the amount of polyol is at least 6, 7, 8, 9, 10, 11, 12, 13, 14, or 15 wt. %, of a polyol.

A variety of commercially available polyols can be utilized in curable compositions of the present disclosure. Useful polyols include polyether polyol, polyester polyol, and combinations thereof.

When higher molecular weight polyols (i.e., polyols having weight average molecular weights of at least about 2,000) are used, it is often desirable that the polyol component be “highly pure” (i.e., the polyol approaches its theoretical functionality—e.g., 2.0 for diols, 3.0 fortriols, etc.). Such highly pure polyols generally have a ratio of polyol molecular weight to weight % hydroxyl equivalent weight of at least about 800, typically at least about 1,000, and more typically at least about 1,500. For example, a 12,000 molecular weight polyol with 8 weight % hydroxyl equivalent weight has such a ratio of 1,500 (i.e., 12,000/8=1,500).

Examples of (e.g. highly pure) polyols include those available from Covestro AG of Luverkusen, Germany, under the trade designation, ACCLAIM, and certain of those under the trade designation, ARCOL.

### Curing Agent

The curable composition typically further contains one or more curing agents. The term “curing agent” is used broadly to include not only those materials that are conventionally regarded as curatives but also those materials that catalyze or accelerate the reaction of the curable material, as well as those materials that may act as both curative and catalyst or accelerator. It is also possible to use two or more curing agents in combination. The curing agent may be a heat-activated curative or a light-activated curative. The cure from a light-activated curative can optionally be accelerated by elevated temperature (e.g., 40-80° C.).

In some embodiments, the adhesive comprises a first photoacid curing agent (e.g. O432 and CPI6976) that absorbs light, and then generates an acid. The acid catalyzes a polymerization of the epoxy groups and polyol. Exposure to light typically occurs after the adhesive is applied to the concrete or pavement. Alternatively, an epoxy curative may also be incorporated into a primer that is applied to a surface (e.g. concrete or pavement surface). The adhesive is then adhered to the primed surface. In this embodiment, the curable adhesive composition may lack a curing agent. The epoxy groups react with the polyol at a slow rate in the absence of curing agent.

Suitable curing agents include, but are not limited to, curing agents disclosed in U.S. Pat. No. 4,503,211 (Robins); U.S. Pat. No. 4,751,138 (Tumey, et al.); and U.S. Pat. No. 10,774,245 (Emslander et al.), the disclosures of all of which are incorporated by reference in their entirety.

The amount of the photoinitiator used in the UV-curable pressure-sensitive adhesive composition in a reactive polyacrylate/epoxy resin hybrid system with reactive functional groups is very small, but the amount thereof has a great impact on the curing speed and storage stability of the UV-curable pressure-sensitive adhesive composition.

The photoinitiator may be a cationic photoinitiator, including but not limited to, onium salts and cationic organometallic salts, both of which are described in U.S. Pat. No. 5,709,948 and photoactivatable organometallic complex salts such as those described in U.S. Pat. Nos. 5,059,701; 5,191,101; and 5,252,694. Suitable cationic photoinitiators including but not limited to the following compounds: diaryl iodonium salt, triaryl sulfonium salt, alkyl sulfonium salt, iron aromatic hydrocarbon salt, sulfonyloxanone, and triaryl siloxane. In some embodiments, the following compounds are used: triarylsulfonium hexafluorophosphate salts or hexafluoroantimonate salts, sulfonium hexafluoroantimonate salts, sulfonium hexafluorophosphate salts, and iodonium hexafluorophosphate salts.

The onium salt photoinitiator applicable to the present invention includes, but is not limited to, iodonium and sulfonium complex salts. Suitable aromatic iodonium complex salts are described more fully in U.S. Pat. No. 4,256,828. Useful aromatic iodonium complex salts include a salt of a general formula as follows:

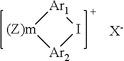

Ar₁ and Ar₂ are identical or different, each comprising aryl having about 4 to 20 carbon atoms. Z is selected from the group consisting of oxygen, sulfur, carbon-carbon bonds;

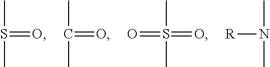

R may be aryl (having about 6 to 20 carbon atoms, such as phenyl) or acyl (having about 2 to 20 carbon atoms, such as acetyl or benzoyl); and

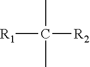

R₁ and R₂ are selected from the group consisting of hydrogen, alkyl having about 1 to 4 carbon atoms, and alkenyl having about 2 to 4 carbon atoms.

m is 0 or 1; and

X has a DQn chemical equation, where D is a metal in families IB to VIII or nonmetal in families from IIIA to VA in the periodic table of elements, or a combination thereof, D also includes hydrogen; Q is halogen atom; and n is an integer within 1 to 6. The metal is preferably copper, zinc, titanium, vanadium, chromium, magnesium, manganese, iron, cobalt, or nickel, and the nonmetal is advantageously boron, aluminium, antimony, tin, arsenic and phosphorus. Halogen Q is preferably chlorine or fluorine. Suitable examples of anions include, but are not limited to, BF₄⁻, PF₆⁻, SbF₆⁻, FeCl₄⁻, SnCl₅⁻, AsF₆⁻, SbF₅OH⁻, SbCl₆⁻, SbF₅⁻², AlF₅⁻², GaCl₄⁻, InF₄⁻, TiF₆⁻², ZrF₆⁻, and CF₃SO₃⁻. The anions are preferably BF₄⁻, PF₆⁻, SbF₆⁻, AsF₆⁻, SbF₅OH⁻, and SbCl₆⁻. More preferably, the anions are SbF₆⁻, AsF⁻ and SbF₅OH⁻.

More preferably, Ar₁ and Ar₂ are selected from the group consisting of phenyl group, thienyl group, furanyl group, and pyrazolyl group. The Ar₁ and Ar₂ groups may optionally comprise one or a plurality of condensed benzocycles (e.g., naphthyl, benzothienyl, dibenzothienyl, benzofuranyl, and dibenzofuranyl). The aryl groups may also be substituted by one or a plurality of non-alkaline groups as required, if they do not substantially react with epoxy compounds and hydroxy functional groups.

Aromatic sulfonium complex salt initiators applicable to the present invention may be expressed by the following general formula:

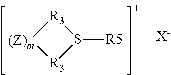

wherein R₃, R₄ and R₅ are identical or different, provided that at least one of R₃, R₄ and R₅ is aryl. R₃, R₄ and R₅ may be selected from the group consisting of aromatic portions comprising about 4 to 20 carbon atoms (e.g., substituted and unsubstituted phenyl, thienyl and furyl) and alkyl comprising about 1 to 20 carbon atoms. R₃, R₄ and R₅ are each preferably an aromatic portion; and Z, m, and X are all those as defined for the sulfonium complex salt above.

If R₃, R₄ and R₅ are aromatic groups, they may optionally comprise one or a plurality of condensed benzocycles (e.g., naphthyl, benzothienyl, dibenzothienyl, benzofuranyl, and dibenzofuranyl). The aryl groups may also be substituted by one or a plurality of non-alkaline groups as required, if they do not substantially react with epoxy compounds and hydroxy functional groups.

In one example of the present invention, triaryl substituted salts such as triphenyl sulfonium hexafluoroantimonate, triphenylsulfonium hexafluorophosphate, and p-phenyl (phenylthio) biphenyl sulfonium hexafluoroantimonate are preferred sulfonium salts. Other sulfonium salts useful in the present invention are described more fully in U.S. Pat. Nos. 4,256,828 and 4,173,476.

The onium salt photoinitiators useful in the present invention are photosensitive in the ultraviolet region of the spectrum. However, they can be sensitized to the near ultraviolet and the visible range of the spectrum by sensitizers for known photolyzable organic halogen compounds. Illustrative sensitizers include colored aromatic polycyclic hydrocarbons, as described in U.S. Pat. No. 4,250,053, and sensitizers such as described in U.S. Pat. Nos. 4,256,828 and 4,250,053. Suitable sensitizers should be chosen so as to not interfere appreciably with the cationic cure of the epoxy resin in the adhesive composition.

Another type of photoinitiators applicable to the present invention includes photo-activable organic metallic complex salts, such as those described in U.S. Pat. No. 5,059,701 (Keipert), U.S. Pat. No. 5,191,101 (Palazzotto et al.), and U.S. Pat. No. 5,252,694 (Willett et al.). These organic metal cationic salts have a general formula as follows:

[(L₁)(L₂)Mₘ]e⁺X⁻

where Mₘ represents an element selected from families IVB, VB, VIB, VIIB, and VIII in the periodic table of elements, and is preferably Cr, Mo, W, Mn, Re, Fe or Co; L₁ represents no ligand, or 1 or 2 ligands that contribute π electrons, wherein the ligands may be the same or different, and each ligand may be selected from the group consisting of carbocyclic aromatic and heterocyclic aromatic compounds which are substituted and unsubstituted by substituted and unsubstituted alicyclic and cyclic unsaturated compounds. Each of the compounds may contribute 2 to 12 pi electrons to a valence shell of the metal atom M. L₁ is advantageously selected from the group consisting of substituted and unsubstituted η3-allyl, η5-cyclopentadienyl and η7-cycloheptane compounds, and η6-aromatics from η6-benzene and substituted η6-benzene compounds (e.g., xylene) and compounds with 2-4 fused rings, each ring being able to contribute 3 to 8 π electrons to the valence shell of metal atom M.

L₂ represents no ligand or one to three ligands that contribute an even number of a electrons, wherein the ligands may be the same or different, and each ligand may be selected from the group consisting of carbon monoxide, nitrite onium, triphenylphosphine, triphenylantimony, and phosphorus, arsenic, antimony derivatives, under the condition that the total charges contributed by L₁ and L₂ to Mₘ result in net residual positive charges to e of a complex.

e is an integer of 1 or 2, the residual charge in coordination with cations; and X is a halogen-containing anion in coordination, as stated above.

Examples of organic metal complex cationic salts suitable for use as the photo-activable catalysts in the present invention include, but not limited to, the following:
[(η-6-benzene)(η-5-cyclopentadienyl)Fe]⁺[SbF₆]⁻,
[(η-6-toluene)(η-5-cyclopentadienyl)Fe]⁺[AsF₆]⁻,
[(η-6-xylene)(η-5-cyclopentadienyl)Fe]⁺[SbF₆]⁻,
[(η-6-isopropylbenzene)(η-5-cyclopentadienyl)Fe]⁺[SbF₆]⁻,
[(η-6-xylene (mixed isomer))(η-5-cyclopentadienyl)Fe]⁺[SbF₆]⁻,
[(η-6-xylene (mixed isomer))(η-5-cyclopentadienyl)Fe]⁺[PF₆]⁻,
[(η-6-o-xylene)(η-5-cyclopentadienyl)Fe]⁺[CF₃SO₃]⁻,
[(η-6-m-xylene)(η-5-cyclopentadienyl)Fe]⁺[BF₄]⁻,
[(η-6-1,3,5-trimethylbenzene)(η-5-cyclopentadienyl)Fe]⁺[SbF₆]⁻,
[(η-6-hexamethylbenzene)(η-5-cyclopentadienyl)Fe]⁺[SbF₅OH]⁻,
[(η-6-fluorene)(η-5-cyclopentadienyl)Fe]⁺[SbF₆]⁻.

In one example of the present invention, the required organic metal complex cationic salts include one or more of the following compounds:
[(η-6-xylene (mixed isomer))(η-5-cyclopentadienyl)Fe]⁺[SbF₆]⁻,
[(η-6-xylene (mixed isomer))(η-5-cyclopentadienyl)Fe]⁺[PF₆]⁻,
[(η-6-xylene)(η-5-cyclopentadienyl)Fe]⁺[SbF₆]⁻,
[(η-6-1,3,5-trimethylbenzene)(η-5-cyclopentadienyl)Fe]⁺[SbF₆]⁻,

Suitable commercially-available initiators include, but not limited to, DOUBLECURE1176, 1193 (Double Bond Chemical Ind. Co., Ltd.) and IRGACURE™ 261, and cationic organic metallic complex salts (BASF). Photoinitiators include, but not limited to, azo initiators and peroxide initiators, such as azobisisobutyronitrile (AIBN), azodiisoheptanitrile (ABVN), 2,2′-azo-bis-(2-methylbutyronitrile) (AMBN), benzoyl peroxide (BPO), and persulfate.

In the composition of the present invention, the content of the photoinitiator is 0.05 to 5 parts by weight, preferably 1-2 parts by weight. Generally speaking, the curing speed of the adhesive composition increases as a result of an increase of the content of the photoinitiator. When the amount of the used photoinitiator is too low, the required radiation energy of UV during curing is high, and the curing speed is slow. On the contrary, when the amount of the used photoinitiator is too great, the required radiation energy of UV during is very low and the curing speed is too fast. Even under sunlight or fluorescent lamp light (containing a small amount of UV light), the photoinitiator can be cured, thereby impacting the storage stability at room temperature.

Curable compositions commonly include at least 0.5, 0.75, or 1 wt. % and no greater than 10, 9, 8, 7, 6, or 5 wt. % of curing agent(s) based on the total weight of thermoplastic block copolymer, epoxy and polyol. Commonly, the curing agent is selected from the group consisting of an amine curing agent, a photoinitiator, and combinations thereof.

### Optional Additives

The curable composition may optionally further contain one or more additives such as, for example, an additive selected from the group consisting of polymeric beads, a styrenic block copolymer, an epoxidized natural rubber, and combinations thereof. In some preferred embodiments, the curable composition comprises up to 5 wt. % of the beads, such as the expandable polymeric beads available under the trade designation DUALITE, from Chase Corp., Westwood, MA, USA. In some preferred embodiments, the curable composition comprises 10 wt. % of the styrenic block copolymer. In some preferred embodiments, the curable composition comprises up to 60 wt. % of the epoxidized natural rubber.

Curable compositions may also contain one or more additional conventional additives. Preferred additives may include, for example, tackifiers, plasticizers, dyes, antioxidants, UV stabilizers, and combinations thereof. Such additives can be used if they do not affect the superior properties of the pressure-sensitive adhesives.

If tackifiers are used, then up to 50% by weight, preferably less than 30% by weight, and more preferably less than 5% by weight, based on the dry weight of the curable composition would be suitable. In some embodiments no tackifier is used. Suitable tackifiers for use with (meth)acrylate polymer dispersions include a rosin acid, a rosin ester, a terpene phenolic resin, a hydrocarbon resin, and a cumarone indene resin. The type and amount of tackifier can affect properties such as contactability, bonding range, bond strength, heat resistance and specific adhesion.

Curable compositions as disclosed herein may be prepared by methods know to those of ordinary skill in the relevant arts. For example, the curable composition may be prepared by combining the copolymer with an epoxy resin, polyol, curing agent, and optionally coating the mixture. In some embodiments, the combining step comprises melt blending. In some embodiments, the combining step comprises solvent blending.

### Physical Properties of the Adhesive or Article

The physical properties of the adhesive composition and articles can be characterized utilizing various test methods.

The uncured adhesive exhibits good initial pressure sensitive adhesive properties. In some embodiments, the uncured adhesive has an elastic shear modulus (G′) at 5° C. of less than or equal to 1, 0.5 or 0.1 MPa. In some embodiments, the uncured adhesive has a G′ at 23° C. of less than 0.5, 0.2, 0.1, or 0.05 MPa. In some embodiments, the uncured adhesive has a G′ of less than 0.1 MPa for a temperature in the range of 25 to 70° C. The G′ can be lowered by reducing the crosslinking (e.g. polyol) or adding tackifier and/or plasticizer. The G′ can also be lowered by increasing the temperature at which the adhesive is applied.

In some embodiments, the cured adhesive has an elastic modulus E′ at 23° C. of greater than a comparative PSA adhesive. In some embodiments, cured adhesive has an elastic shear modulus (G′) at 5° C. of greater than 0.1, 0.5, 1, 2, 3, 4, 5, 6, 7, 8, 9, 10, 11, 12, 13, or 14 MPa. In some embodiments, cured adhesive has an elastic shear modulus (G′) at 23° C. of greater than 0.05, 0.1, 0.5, 1, 2, 3, 4, 5, 6, 7, 8, 9, or 10 MPa. In some embodiments, cured adhesive has an elastic shear modulus (G′) at 70° C. of greater than 0.05, 0.1, 0.2, 0.3, 0.4, or 0.5, MPa.

In some embodiments, the E′ of the cured adhesive is at least 1E+05 (1×10⁶) Pa, 5E+05 Pa, 1E+06 Pa, 5E+06 Pa, 1E+07 Pa, 5E+07 Pa, 1E+08 Pa. In some embodiment, E′ of the cured adhesive is no greater than 1E+09 Pa or 5E+08 Pa, 1E+08 Pa, 5E+07 Pa, 1E+07 Pa, or 5E+06 Pa.

In some embodiments, the cured adhesive has a Tan(δ) max of less than a comparative adhesive. In some embodiments, the Tan(δ) max is less than 120, 110, 100, 90, or 80° C. In some embodiments, the Tan(δ) max is less than 70, 60, 50, 40, 30 or 20° C. In some embodiments, the Tan(δ) max is at least 10, 20, 30, 40, 50, 60, or 70° C.

In some embodiments, the cured adhesive composition has a gel content of at least 50, 60, 70, 80, or 90 wt. %. In some embodiments, the cured adhesive composition has a static shear of greater than 10,000 minutes. In some embodiments, the cured adhesive composition has an impact strength of 0.4 to 1.8 Joules as measured by Tensile Impact test method. In some embodiments, the cured adhesive composition has a push out strength of 50 to 1040 Joules as measured by Push Out Strength test method. In some embodiments, the cured adhesive composition has a dynamic shear of 0.5 to 7.32 MPa as measured by Dynamic Shear test method.

### Inorganic Particles

The adhesive (e.g. tape) articles described herein comprise inorganic particles disposed on a major of the article. Alternatively, an article can be made in-situ by applying the curable adhesive to concrete or pavement and applying inorganic particles on the surface of the curable adhesive.

The term inorganic particles refers to particles comprising at least 50 wt. % inorganic components. In typical embodiments, the inorganic particles comprise at least 55, 60, 65, 70, 75, 80, 85, 90, 95, wt. % or greater of inorganic components. For example, glass and ceramic beads are typically 100% inorganic components whereas highly filled inorganic composite particles may further comprise at least 25-50% of organic polymeric binder material. In some embodiments, the amount of organic polymeric material is no greater than 45, 40, 30, 35, or 30 wt. % of the inorganic particles. One illustrative retroreflective element that comprises a polymeric composite core is described in US 2018/0291175; incorporated herein by reference.

The inorganic particles are typically durable and in some favored embodiments suitable for outdoor use. Representative inorganic particles include traction particles and reflective particles.

In some embodiments, the inorganic particle may be characterized as traction particles that are present to increase friction. In the case of pavement surfaces for motor vehicles, traction particles may also be referred to as skid-resistant particles. In the case of steps and sidewalks, traction particles may also be referred to as anti-slip particles. Such particles are often glass or ceramic such as quartz or aluminum oxide or similar abrasive material. Traction particles typically have an average size of at least 50, 75, or 100 microns up to 1 mm. Traction particles are typically irregular in shape. Skid-resistant granules are typically used to provide a marking material having a skid resistance of 45 BPN or above, as measured by a portable skid resistance tester calibrated and operated in accordance with ASTM E303-93(2018).

Preferred skid-resistant granules include a blend of fine aluminum oxide granules and larger aluminum oxide granules provides acceptable, long-lasting skid resistance. The particles may be treated with a coupling agent that improves adhesion between the particles and the (e.g. binder) layer the particles are embedded in.

In other embodiments, the inorganic particle may be characterized as reflective or retroreflective particles. Illustrative reflective particles include diffuse and specular reflective pigment particles. Diffuse reflective pigment particles are typically white in appearance. Common diffuse reflective pigments include TiO₂, barium sulfate, and zinc oxide. Reflective particles may be incorporated into the curable adhesive composition or into an additional (e.g. binder) layer on the surface of the article in an amount ranging from 10 to 80 wt. %. In some embodiments, the article comprises 60-70 wt. % of (e.g. TiO₂) in a binder layer comprises glass or ceramic beads. Specular reflective pigment particles are generally thin and plate-like and are part of the binder layer, the organic core (a core comprising essentially only an organic binder material) of an element, or an organic binder coating on an inorganic particle that together make up a composite core of an element. Light striking the pigment particles is reflected at an angle equal but opposite to the angle at which it was incident. Suitable examples of specular pigments include pearlescent pigments, mica, and nacreous pigments. Typically, the amount of specular pigment present in the binder layer is at least 15 percent by weight ranging up to 40 or 50 percent by weight.

The term “retroreflective” as used herein refers to the attribute of reflecting an obliquely incident radiation ray in a direction generally antiparallel to its incident direction such that it returns to the radiation source or the vicinity thereof.

In some embodiments, the inorganic particles comprise retroreflective glass or ceramic beads also referred to as “microspheres”. The terms “beads” and “microspheres” are used interchangeably and refer to particles that are substantially spherical.

Any existing retroreflective glass or glass ceramic beads can be used. This includes, for example, those glass or glass ceramic beads described in U.S. Pat. Nos. 3,493,403; 3,709,706; 4,564,556; and 6,245,700, all of which are incorporated herein in their entirety.

Some exemplary glass compositions include those described, for example, in U.S. Pat. Nos. 6,245,700 and 7,524,779, both of which are incorporated herein in their entirety. In some embodiments, the glass or glass ceramic beads include at least one or more of, for example, a lanthanide series oxide, aluminum oxide, TiO₂, BaO, SiO₂, or ZrO₂.

Retroreflective glass or glass ceramic beads are typically “solid” or in other words not hollow, i.e., free of substantial cavities or voids. For use as lens elements, the beads are preferably spherical and preferably solid (i.e. non-porous). Solid beads are typically more durable than hollow beads. Solid beads can also focus light more effectively than hollow beads, leading to higher retroreflectivity.

Retroreflective glass or glass ceramic beads are typically transparent meaning that the beads when viewed under an optical microscope (e.g., at 100×) have the property of transmitting rays of visible light so that bodies beneath the beads, such as bodies of the same nature as the beads, can be clearly seen through the beads when both are immersed in oil of approximately the same refractive index as the beads. Although the oil should have an index of refraction approximating that of the beads, it should not be so close that the beads seem to disappear (as they would in the case of a perfect index match). The outline, periphery, or edges of bodies beneath the beads are clearly discernible.

In some embodiments, the glass or glass ceramic beads have mean or average diameters of 30-200 microns, or greater. In some embodiments, the glass or glass ceramic beads have mean or average diameters of at least 50 or 60 microns and typically no greater than 150, 100 or 90 microns. In some embodiment, the first and second beads of different sizes may be present. If processing the material in an extruder, the beads loaded in the polymer should be small enough to easily pass through the extruder. In one embodiment, these first beads should have an average diameters less than 250 microns. In one embodiment, these first beads have an average diameter between 60-90.

Various transparent glass and ceramic beads, suitable for retroreflection, are known in the art. Such beads generally have a refractive index ranging from about 1.5 to about 2.6. Lower index beads, having a refractive index ranging between 1.5 and 1.9, perform well in dry conditions, Higher index beads, having a refractive index ranging between 1.85 and 2.45, perform well at night and/or wet conditions. Thus, it is a common to include both lower and higher index beads for. pavement markings

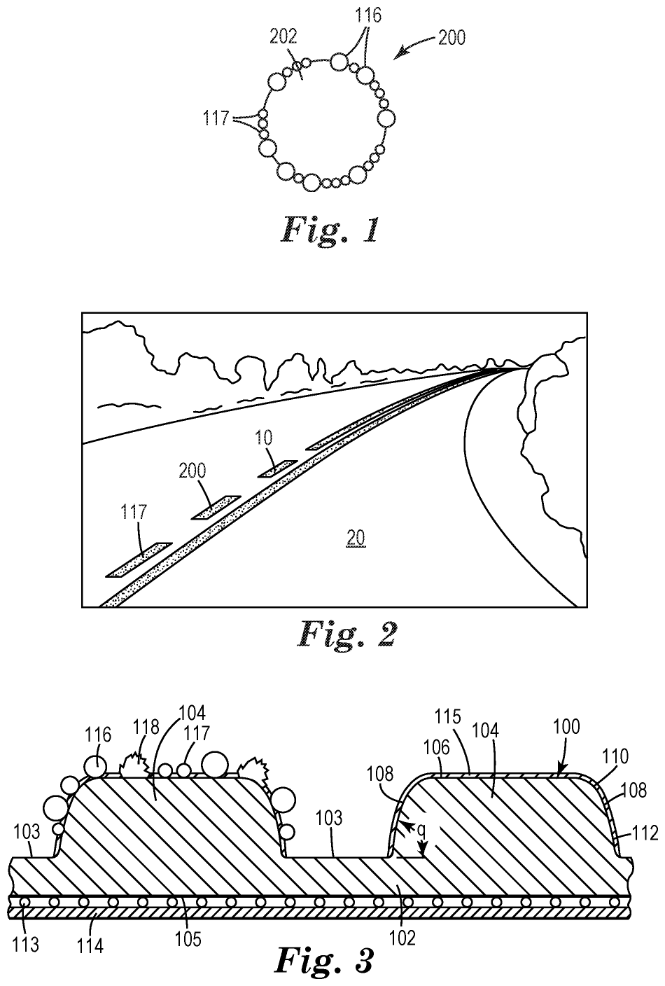

With reference to FIG. 1, in some embodiments the inorganic particle may be characterized as retroreflective element 200 that comprises glass beads 117 alone or in combination with higher index beads (e.g. having a refractive index of at least 2.20 or greater) 116 partially embedded in the surface of a core 202. The core is typically substantially larger than the beads. For example the average core diameter may range from about 0.2 to about 10 millimeters. The core may comprise an inorganic material. Glass-ceramics are also useful as a core material. The crystalline phase acts to scatter light resulting in a semi-transparent oropaque appearance. Alternatively, the core may comprise an organic material such as a thermoplastic or bonded resin core, i.e. a crosslinked cured resin such as an epoxy, polyurethanes, alkyds, acrylics, polyesters, phenolics and the like. Various epoxies, polyurethane, and polyesters are generally described in U.S. Pat. Nos. 3,254,563; 3,418,896 and 3,272,827. The core may be a composite comprising an inorganic particle that is coated with an organic material. In the latter case, the organic material serves as a binder to affix the beads to the outside surface of the core.

Although the retroreflective elements may be prepared from a non-diffusely reflecting bonded resin core in combination with specularly reflecting beads (e.g. vapor coating the beads with aluminum), this approach results in less durable retroreflective elements due to the use of metal which may be susceptible to chemical degradation. Less durable retroreflective elements would also result by incorporating metals (e.g. aluminum) into the core. In some embodiments, the retroreflective elements comprise at least one non-metallic light scattering material dispersed within the core. Reflective elements may be made by known processes, such as described in U.S. Pat. No. 5,917,652; 5,774,265; and 2005/0158461.

In some embodiments, the inorganic particles are at least partially embedded in the curable adhesive layer. In some embodiments, the inorganic particles are at least partially embedded in an additional (e,g, binder) layer disposed on a major surface of the article. When partially embedded, the inorganic particles are also partially exposed on the surface of the adhesive layer or article. In some embodiments, the inorganic particles are completely embedded in the adhesive or binder layer. During use of the article the surface is abraded and the inorganic particles become exposed. The adhesive layer may be continuous or discontinuous. In the case of traction particles and some types of retroreflective elements, the inorganic particles may be partially exposed on a major surface of the adhesive article. In the case of reflective pigment particles and enclosed-lens retroreflective sheeting, the retroreflective elements may be fully embedded in the binder layer and not exposed on a major surface of the adhesive article.

### Pavement Markings and Articles

In some embodiments, the (e.g. glass or ceramic) beads and/or retroreflective elements are employed in a liquid-applied pavement marking application. With reference to FIG. 2, the beads 117 and/or reflective elements 200 are sequentially or concurrently dropped onto the curable adhesive composition described herein 10 that is provided on pavement surface 20. Alternatively or in combination thereof, the (e.g. glass or ceramic) beads and/or reflective pigment may be combined with the curable adhesive composition described herein prior to application to the pavement surface 20. Typical pavement surfaces include asphalt, concrete, and the like. Pavement surfaces are typically substantially solid and include a major portion of inorganic materials.

In other embodiments, the curable adhesive composition described herein in applied to a pre-formed retroreflective sheeting. Various types of retroreflective sheeting are known including exposed lens, encapsulated lens, embedded lens, or enclosed lens sheeting. Representative pavement-marking sheet material (tapes) are described in U.S. Pat. No. 4,248,932 (Tung et al.), U.S. Pat. No. 4,988,555 (Hedblom); U.S. Pat. No. 5,227,221 (Hedblom); U.S. Pat. No. 5,777,791 (Hedblom); and U.S. Pat. No. 6,365,262 (Hedblom).

Pavement marking tape and sheet material typically include a backing, a layer of binder material, and a layer of beads partially embedded in the layer of binder material. The backing, which is typically of a thickness of less than about 3 millimeters, can be made from various materials, e.g., polymeric films, metal foils, and fiber-based sheets. Suitable polymeric materials include acrylonitrile-butadiene polymers, millable polyurethanes, and neoprene rubber. The backing can also include particulate fillers or skid resistant particles. The binder material can include various materials, e.g., vinyl polymers, polyurethanes, epoxides, and polyesters, optionally with colorants such as inorganic pigments, including specular pigments.

For reflective sheeting that is suitable for reflective signage, apparel, or other uses, the binder that affixes the beads is typically transparent. Transparent binders are applied to a reflective base or may be applied to a release-coated support, from which after solidification of the binder, the beaded film is stripped and may subsequently be applied to a reflective base or be given a reflective coating or plating. The reflective elements comprising beads and/or the beads are typically coated with one or more surface treatments that alter the pavement marking binder wetting properties and/or improve the adhesion of the reflective elements comprising beads or the beads in the binder. The reflective elements are preferably embedded in the pavement marking binder to about 20-40%, and more preferably to about 30% of their diameters such that the reflective elements are adequately exposed.

The retroreflectance (i.e. dry white patch brightness) of the beads and/or retroreflective elements for an entrance angle of −4° and a 0.2° observation angle is at least 8, 9, 10, 11, 12, 13, 14 or 15 (Cd/m²)/lux. In some embodiments, the retroreflectance of the beads and/or retroreflective elements is no greater than 15, 14, 13, 12, 11, 10, 9, or 8 (Cd/m²)/lux. Beads of lower refractive index and brightness (in air) can be used with higher refractive index beads. Dry white patch brightness values are determined using a retroreflectometer (Road Vista 932, obtained from Road Vista LLC, San Diego, CA). The device directs white light onto a flat monolayer of glass microspheres partially sunk into a diffuse white backing material (3M 7000-109-3 Patch Brightness Tape) at a set entrance angle to the normal of the partially sunk monolayer. The diffuse white backing material without the monolayer of glass microspheres had a whiteness index of 86.

The retoreflectance of the retroreflective sheet material (e.g. pavement marking tape) can be measured according to ASTM-E1710. The retroreflectance is typically at least 100, 200, 300, 400 or 500 (mCd/m²)/lux ranging up to 2000 (mCd/m²)/lux or greater.

Patterned retroreflective (e.g. pavement) markings advantageously provide vertical surfaces, e.g., defined by protrusions, in which the beads are partially embedded. Because the light source usually strikes a pavement marker at high entrance angles, the vertical surfaces, containing embedded beads, provide for more effective retroreflection. Vertical surfaces also tend to keep the beads out of the water during rainy periods thereby improving retroreflective performance.

For example, FIG. 3 shows patterned pavement marker 100 containing a (e.g. resilient) polymeric base sheet 102 and a plurality of protrusions 104. For illustrative purposes, only one protrusion 104 has been covered with beads and antiskid particles. Base sheet 102 has front surface 103 from which the protrusions extend, and back surface 105. Base sheet 102 is typically about 1 millimeter (0.04 inch) thick, but may be of other dimensions if desired. Optionally, marker 100 may further comprise scrim 113 and/or adhesive layer 114 on back surface 105. Protrusion 104 has top surface 106, side surfaces 108, and in an illustrative embodiment is about 2 millimeters (0.08 inch) high. Protrusions with other dimensions may be used if desired. As shown, side surfaces 108 meet top surface 106 at a rounded top portions 110. Side surfaces 108 preferably form an angle θ of about 70° at the intersection of front surface 103 with lower portion 112 of side surfaces 108. Protrusion 104 is coated with pigment-containing binder layer 115. Embedded in binder layer 115 are a plurality of beads 117 and a plurality of a second beads 116 (e.g. having a higher refractive index than the beads). Optionally, antiskid particles 118 may be embedded on binder layer 115.

Pavement marking sheeting can be made by a variety of known processes. A representative example of such a process includes coating onto a backing sheet a mixture of resin, pigment, and solvent, dropping beads as described herein onto the wet surface of the backing, and curing the construction. A layer of adhesive can then be coated onto the bottom of the backing sheet. U.S. Pat. No. 4,988,541 (Hedblom); incorporated by reference, discloses a preferred method of making patterned pavement markings. Optionally, a scrim (e.g., woven or nonwoven) and/or an adhesive layer can be attached to the back side of the polymeric base sheet, if desired.

The binder layer of FIGS. 2 and 3 as well as the core of the retroreflective element depicted in FIG. 1 comprise a light transmissive material so that light entering the retroreflective article is not absorbed but is instead retroreflected by way of scattering or reflection off of pigment particles in the light-transmissive material. Vinyls, acrylics, epoxies, and urethanes are examples of suitable mediums. Urethanes, such as are disclosed in U.S. Pat. No. 4,988,555 (Hedblom) are preferred binder mediums at least for pavement markings. The binder layer typically covers selected portions of the protrusions so that the base sheet remains substantially free of the binder.

The binder layer of FIGS. 2 and 3 as well as the core of FIG. 1 typically comprise at least one pigment such as a diffusely reflecting or specularly reflecting pigment, as previously described.

In lieu of or in addition to combining transparent beads with a reflective (e.g. pigment containing) binder and/or element core, the beads may comprise a reflective (e.g. metallic) coating. Typically, the metallic coating is absent from the portion of the outside surface of the bead that is oriented to receive the light that is to be retroreflected, and present on the portion of the outside surface of the bead that is oriented opposite to the direction from which light that is to be retroreflected is incident. For example, in FIG. 1, a metallic coating may be placed at the interface between bead 117 and core 202. In FIG. 3, a reflective layer may be placed at the interface between the bead 117 and the binder 115 such as shown in U.S. Pat. No. 6,365,262. Metallic coatings may be placed on beads by physical vapor deposition means, such as evaporation or sputtering. Full coverage metallic coatings that are placed on beads can be partially removed by chemical etching.

### Backing

In some embodiments, the adhesive article further comprises a backing. The backing may be disposed within the curable adhesive layer. For example, a fabric backing (e.g. scrim) may be disposed between two layers of the curable adhesive composition. In another embodiment, the adhesive article comprises a backing between a binder layer and the curable adhesive layer. For example, the curable adhesive composition may be disposed on a backing such as the non-retroreflective major surface of retroreflective sheeting. Various backings of retroreflective sheeting, such as an acrylonitrile butadiene rubber sheet, have previously been described. Backing materials are also described in U.S. Pat. Nos. 4,117,192 or 4,490,432; incorporated herein by reference.

Other flexible backings include polyolefins such as polyethylene, polypropylene (including isotactic polypropylene), polystyrene, polyester, polyvinyl alcohol, poly(ethylene terephthalate), poly(butylene terephthalate), poly(caprolactam), poly(vinylidene fluoride), polylactides, cellulose acetate, and ethyl cellulose and the like. Commercially available backing materials useful in the disclosure include silicone-coated polyester liners (available from Mitsubishi Polyester Film Inc., Greer, S.C.), kraft paper (available from Monadnock Paper, Inc.); cellophane (available from Flexel Corp.); spun-bond poly(ethylene) and poly(propylene), such as TYVEK and TYPAR (available from DuPont, Inc.); and porous films obtained from poly(ethylene) and poly(propylene), such as TESLIN (available from PPG Industries, Inc.), and CELLGUARD (available from Hoechst-Celanese).

Backings may also be prepared of fabric such as woven fabric formed of threads of synthetic or natural materials such as cotton, nylon, rayon, glass, ceramic materials, and the like or nonwoven fabric such as air laid webs of natural or synthetic fibers or blends of these. The backing may also be formed of metal, metalized polymer films, or ceramic sheet materials may take the form of any article conventionally known to be utilized with pressure-sensitive adhesive compositions such as labels, tapes, signs, covers, marking indicia, and the like.

### Method of Making

The above-described curable compositions can be coated on a substrate using conventional coating techniques modified as appropriate to the particular substrate. For example, these curable compositions can be applied to a variety of solid substrates by methods such as roller coating, flow coating, dip coating, spin coating, spray coating knife coating, and die coating. The curable composition may also be coated from the melt. These various methods of coating allow the compositions to be placed on the substrate at variable thicknesses thus allowing a wider range of use of the compositions. Coating thicknesses may vary as required for a specific application.

The thickness of the curable adhesive layer is typically at least 25, 50, 75, 100, 125, 150, 175, or 200 microns and typically no greater than 1000 microns. When the second layer is formed from thermal coextrusion, the second layer is typically at least 100 microns. In some embodiments, the total thickness of the first and second layers is no greater than 2000, 1500, or 1000 microns.

In one preferred embodiment, the adhesive article is prepared by thermal coextrusion. The curable adhesive composition is initially fed into an extruder (typically a single screw extruder) which softens and grinds the resin into small particles suitable for extrusion. The curable adhesive composition may be added to extrude in any convenient form, including pellets, billets, packages, strands, and ropes. Next, optional additives are combined with the curable adhesive composition and fed to the kneading zone of extruder. The mixing conditions (e.g., screw speed, screw length, and temperature) are selected to achieve optimum mixing. Where no mixing is needed, e.g., where there are no additives, the kneading step may be omitted.

Following melt-mixing, the extrudable curable adhesive composition is metered through an extrusion die. The extrusion die may be a drop die, contact die, profile die, annular die, or a casting die, as known in the art. A tighter tolerance is defined as the machine (or longitudinal) direction and crossweb (or transverse) direction standard deviation of density or thickness over the average density or thickness (a/x), respectively. The a/x is typically less than about 0.2, less than about 0.1, less than about 0.05, and even less than about 0.025.

The curable adhesive composition may optionally be combined with a liner. Suitable materials for liners include silicone release liners, polyester films (e.g., polyethylene terephthalate films), and polyolefin films (e.g., polyethylene films). The liner and curable composition are typically laminated together between a pair of nip rollers.

Following lamination or after being extruded but before lamination, the curable adhesive composition is optionally exposed to radiation from an electron beam source to crosslink the curable adhesive. Other sources of radiation (e.g., ion beam, thermal and ultraviolet radiation) may be used as well. Crosslinking may also be accomplished by using chemical crosslinking methods based on ionic interactions. Suitable thermal crosslinking agents include epoxies and amines. Preferably, the concentrations are sufficiently low to avoid excessive crosslinking or gel formation before the composition exits the die. Crosslinking improves the cohesive strength of the adhesive composition. Following exposure, the laminate is rolled up onto a take-up roll.

If desired, the smoothness of one or both of the curable adhesive composition surfaces can be increased by using a nip roll to press the adhesive against a chill roll after the adhesive exits the die. It is also possible to emboss a pattern on one or both surfaces of the curable adhesive composition by contacting the adhesive with a patterned roll after it exits the die using conventional microreplication techniques, such as, for example, those disclosed in U.S. Pat. No. 5,897,930 (Calhoun et al.), U.S. Pat. No. 5,650,215 (Mazurek et al.) and the PCT Patent Publication No. WO 98/29516A (Calhoun et al.), all of which are incorporated herein by reference. The replication pattern can be chosen from a wide range of geometrical shapes and sizes, depending on the desired use of the foam. The substantially smooth surface improves microreplication to a higher degree of precision and accuracy.

One or more curable adhesive compositions layers may optionally be combined with a backing layer. Additional layers (not shown) such as tie layers, primers layers or barrier layers also can be included to enhance the interlayer adhesion or reduce diffusion through the construction. In addition, interlayer adhesion of a construction having multiple layers of different compositions by blending a fraction of the composition of the first layer into the composition of the second layer. As known in the art, the extrusion process typically produces orientation due to stretching in the machine direction. Orientation conditions include the temperature, direction(s) of stretch, rate of stretch, and degree of stretch (i.e., orientation ratio).

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted or readily apparent from the context, all parts, percentages, ratios, etc. in the Examples and the rest of the specification are by weight.

TABLE 1
Materials Used in the Examples

| Abbreviation | Description |
|---|---|
| LA2330 | M-B-M acrylic block copolymer with a MFR of 3.7 g/10 min (ISO 1133, |
| | 190° C./2.16 kg), obtained under the trade designation “KURARITY LA2330” |
| | from Kuraray Co., Ltd., Tokyo, Japan |
| LA2140 | M-B-M acrylic block copolymer with a MFR of 31 g/10 min (ISO 1133, |
| | 190° C./2.16 kg), obtained under the trade designation “KURARITY LA2140” |
| | from Kuraray Co., Ltd., Tokyo, Japan |
| 828 | Difunctional bisphenol A/epichlorohydrin derived epoxy resin, obtained under |
| | the trade designation “EPON 828” from Dow Inc., Midland, Michigan |
| 1001 | Difunctional bisphenol A/epichlorohydrin derived epoxy resin, obtained under |
| | the trade designation “EPON 1001F” from Dow Inc., Midland, Michigan |
| 2200 | 2,000 molecular weight propylene oxide polyether diol with low mono-ol, |
| | obtained under the trade designation “ACCLAIM 2200” from CovestroAG, |
| | Luverkusen, Germany |
| OMICURE | An aromatic substituted urea obtained under the trade designation “OMICURE |
| | U-52M” from Huntsman Corporation, Woodlands, Texas |
| 6976 | A cationic UV photoinitiator containing a mixture |
| | of triarylsulfonium hexafluoroantimonate salts in propylene carbonate, obtained |
| | under the trade designation “UVI-6976” from Dow Inc., Midland, Michigan |
| ENR50 | Epoxidized natural rubber with 50% epoxide functional groups, obtained |
| | from Sanyo Corporation, New York, New York |
| 4454 | Polyacrylate elastomer which contains one or more acrylic esters with a small |
| | percentage of carboxy/chlorine cure sites, obtained under the trade designation |
| | “HYTEMP 4454” from ZEON Chemicals L.P., Louisville, Kentucky |
| D1119 | Kraton D1119 P is a clear, linear triblock copolymer based on styrene and |
| | isoprene with a polystyrene content of 22% from Kraton Polymers, Houston |
| | Texas |
| Q3620 | Polystyrene-polyisoprene synthetic rubber block copolymer, obtained under the |
| | trade designation “QUINTAC 3620” from ZEON Chemicals L.P., Louisville, |
| | Kentucky |
| O432 | A cationic UV photoinitiator containing a mixture of triarylsulfonium |
| | hexafluorophosphate salts in propylene carbonate, obtained under the trade |
| | designation “Omnicat Q432” from IGM Resins Charlotte, NC |
| DUALITE | Expandable polymeric beads, obtained under the trade designation, “DUALITE |
| | U025-170D” from Chase Corp., Westwood, Massachusetts |
| IRG 1010 | Sterically hindered phenolic primary antioxidant, obtained under the trade |
| | designation, IRGANOX 1010” from BASF, Florham Park, New Jersey |
| PET1 | Silicone-coated polyester liner, obtained under the trade designation “SILPHAN |
| | S75 B OR30032/0R30022” from Siliconature S.P.A., Godega di Sant'Urbano, |
| | Italy |
| PET2 | Silicone-coated polyester liner, obtained under the trade designation “SILPHAN |
| | S50 D OR30022” from Siliconature S.P.A., Godega di Sant'Urbano, Italy |
| CE-1 | 0.2 mm black, acrylic foam tape, obtained under the trade designation “VHB |
| | Electronic Tape 86420” from 3M Company, St. Paul, Minnesota |
| CE-2 | 0.2 mm acrylic tape, obtained under the trade designation “VHB Tape 4914- |
| | 020” from 3M Company, St. Paul, Minnesota |
| 4013F | Low monol polyether polyol, can be obtained under the trade designation |
| | “PREMINOL S 4013F” from AGC Chemicals Americas, Inc., Exton, |
| | Pennsylvania |
| 250 | Cationic photoinitiator made of a blend of iodonium, (4-methylphenyl)[4- |
| | (2-methylpropyl) phenyl]-, hexafluorophosphate(1-) (75%) in propylene |
| | carbonate, obtained under the trade designation “OMNICAT 250” from IGM |
| | Resins USA Inc., Charlotte, North Carolina |
| ITX | 2-isopropylthioxanthone, obtained from Pfaltz and Bauer Inc., Waterbury, |
| | Connecticut |
| MMA | Methyl methacrylate, obtained from Alfa Aesar, Haverhill, Massachusetts |
| BA | Butyl acrylate, can be obtained from Millipore Sigma, St. Louis, Missouri |
| Ethyl Acetate | Ethyl acetate, can be obtained from Millipore Sigma, St. Louis, Missouri |
| VAZO 67 | 2,2′-azobis(2-methylbutanenitrile), can be obtained under the trade designation |
| | “VAZO 67” from The Chemours Company, Wilmington, Delaware |
| IOTG | Isooctyl thioglycolate, can be obtained from Millipore Sigma, St. Louis, |
| | Missouri |
| PI 2074 | 4-isopropyl-4′-methyldiphenyliodonium tetrakis(pentafluorophenyl)borate, a |
| | cationic photoinitiator obtained under the trade designation “BLUESIL PI |
| | 2074” from Elkem Silicones, East Brunswick, New Jersey |
| PSA 1 | Tackified natural rubber adhesive composition as described in example 1 of US |
| | 5906889 CF |
| Primer 1 | As described in EP 372756B1 |

### Retroreflective Sheet Material 1

A pavement marking material with a top layer comprising a polycaprolactone based polyurethane was prepared comprising at least 50 parts of titanium dioxide pigment coated 7 mils thick onto a 40 mil, highly filled, calendered, flexible acrylonitrile butadiene rubber sheet. Glass beads (1.5 index beads, treated with a flotation agent Momentive Performance Material and skid-resistant particles (aluminum oxide, also treated with 3-amino propyl triethoxy silane) were sprinkled over the surface of the coating. After applying the particles, the polyurethane was fully cured.

### Retroreflective Sheet Material 2

A polyethylene layer was coated on a paper backing The polyethylene layer was heated, and glass beads with average diameter in the range of 40-90 micrometers were cascaded and sunk into the polyethylene layer The depth at which the glass beads were sunk was smaller than the average diameter of the glass beads, and a portion of the microspheres remained exposed above the surface of the polyethylene The coated glass bead layers were vapor coated with a thin layer of aluminum metal to form an aluminum metal mirror layer.

### Test Methods

### Gel Permeation Chromotography (Gpc) Test Method

Samples (e.g. block copolymer) were prepared in tetrahydrofuran (THF, stabilized with 250 ppm BHT) by weighing sample and solvent; the target concentration was approximately 3 milligrams/milliliter. The sample solution was then filtered through a 0.45 micrometer PTFE syringe filter and analyzed by GPC under the following conditions:
Instrument: Agilent 1260 LC
Column set: Waters Styragel HR 5E, 300×7.8 mm I.D.
Col. Heater: 40° C.
Mobile phase: THF (stabilized with 250 ppm BHT) at 1.0 mL/min
Injection volume: 30 microliters
Detector (s): Wyatt DAWN HELEOS-II 18 angle Light Scattering detector
   Wyatt Optilab T-rEX Differential Refractive Index (DRI) detector

Molecular weight results from GPC were determined using light scattering detection in THF eluent and ASTRA 6 from Wyatt Technology Corporation was used for data collection and analysis. The differential refractive index increment (dn/dc) of each sample was experimentally determined in the mobile phase or eluent using a Total Recovery Approach. Results are averages from duplicate injections and all dn/dc values are in mL/g. The experimental dn/dc values were used for molecular weight calculations.
Mₙ=Number-average molecular weight
M_{w}=Weight-average molecular weight
Ð=Dispersity=M_{w}/Mₙ

### Peel Adhesion

Samples for peel adhesion and static shear adhesion testing were prepared by laminating the UV-curable pressure sensitive adhesive tape onto 0.13 mm thick anodized aluminum foil using a hand held rubber roller, except where noted. The test tape was irradiated with 4 J/cm2 (at ca. 1.1 W/cm2) from a 365 nm AC7300 LED light source (Excelitas Technologies, Waltham, MA, USA). The total UVA energy was determined using a POWER PUCK II radiometer equipped with a high power sensing head (available from EIT Incorporated, Sterling, VA). Stainless steel substrates were cleaned with methyl ethyl ketone, 1:1 isopropanol/water, acetone, and then dried with a KIMWIPE (Kimberly-Clark, Irving, TX) unless otherwise noted.

A 12.5 mm wide strip of adhesive tape was applied to anodized aluminum foil, UV-activated, then laminated onto a 1.6 mm thick stainless steel panel using a 2.0 kg rubber roller to give a bonded article. The article was allowed to dwell for 72 hr at CTH conditions. A 90° angle peel test was performed using an MTS Sintech 500/S at 30.5 cm/min peel rate, with data collected and averaged over 10 seconds, according to the test method ASTM Designation D3330/D330M-04. Uncured peel adhesion samples were prepared as above, except the UV-exposure step was skipped.

### Static Shear Adhesion

Static Shear Adhesion was determined according to the test method of ASTM D3654/D3654M-06. A 25.4×12.7 mm UV-cured adhesive tape was applied to anodized aluminum foil, UV-activated, then laminated onto a 1.6 mm thick stainless steel panel using a 2.0 kg rubber roller to give a bonded article. The article was allowed to dwell for 24 hours before a 0.5 kg weight was attached to the assembly by the remaining length of aluminum foil that extended beyond the bonded area and held at 70° C. The time was measured when the adhesive sample failed to hold the weight. Samples were stopped at 10,000 min if they did not fail sooner.

### Push Out Strength

A test tape sample with siliconized PET liners on both surfaces was cut in a circular ring geometry with a 3.11 cm outer diameter, 2.61 cm inner diameter (2.5 mm bond width). One liner was removed exposing the adhesive surface and the tape was adhered to the surface of a square polycarbonate test frame (4.07×4.07×0.3 cm) with a circular hole (2.4 cm diameter) cut in the middle; wherein the tape is centered over the hole. The second liner was removed from the test tape and the tape was irradiated with 4 J/cm2 of 365 nm UV-LED light. The total UVA energy was determined using a POWERPUCK II radiometer equipped with a high power sensing head (available from EIT Incorporated, Sterling, VA). Immediately after irradiation, a polycarbonate circular puck (3.3 cm diameter×0.3 cm thick) was centered over the test tape and adhered to the polycarbonate frame surface using a 10 kg weight which was placed on the bonded polycarbonate puck, tape, polycarbonate frame article for 10 seconds. The weight was removed and the testing fixture was allowed to dwell for 24 hr at CTH. An MTS Sintech 500/S (MTS, Eden Prairie, MN) was then used to separate the puck from the frame, which was held stationary, using a probe through the hole of the frame at a rate of 10 mm/min and the total force was recorded and three replicates were completed for each sample.

### Tensile Impact

Samples were prepared as described in the Push Out Strength method, except the frame and puck substrates were made of stainless steel instead of polycarbonate. The samples were tested at a drop height of 300 mm with a 3 kg mass using an Instron CEAST 9340 Drop tower, wherein the impact was through the hole in the stationary frame such that the puck was separated from the frame. The total energy and failure mode were recorded and three replicates were completed for each sample.

### Dynamic Shear

A stainless steel substrate (25.4×76.2×1.6 mm) was cleaned with methyl ethyl ketone, 1:1 isopropanol/water, acetone, and then dried with a KIMWIPE (Kimberly-Clark, Irving, TX). A 1″ by 1″ tape sample with PET liner on one surface was firmly bonded to the stainless steel substrate opposite the PET liner using finger pressure. The PET liner was then removed. The test tape was irradiated with 4 J/cm2 of 365 nm UV-LED light. The total UVA energy was determined using a POWER PUCK II radiometer equipped with a high power sensing head (available from EIT Incorporated, Sterling, VA). A second clean stainless steel substrate was bonded to the UV-cured tape. The sample was mechanically rolled with a 6.8 kg roller at 305 mm/min to ensure proper adhesion. The sample was allowed to dwell for 24 hr at CTH conditions. The substrates were attached to two separated jaw hooks in an MTS Insight 30 (MTS, Eden Prairie, MN) and separated at a rate of 12.7 mm/min.

### Gel Content

All samples were cut out using a 2.54 cm diameter die, weighed, and then put into a pre-weighed metal pouch. The pouch was submerged in THF for three days. Pouches were taken out of solvent to dry in for 4 h in a 120° C. solvent oven (Blue M model DC-246AG-HP). The samples were then weighed again and the change in weight was recorded.

### Tensile Dynamic Mechanical Analysis

Samples were cured and laminated to a caliper of 800 μm then cut into a 6.35 mm strip and placed on the TA instruments Q800 DMA. The strip was oscillated at 1 Hz with a 2% strain using a temperature ramp from −60° C. to 150° C. at a heating rate of 2° C./min.

### Shear Rheology

Shear rheology was measured using a Discovery Hybrid parallel plate rheometer (TA Instruments) to characterize the physical properties of each sample as a function of temperature. Rheology samples were prepared by punching out a section of the PSA with an 8 mm circular die, removing it from the release liners, centering it between 8 mm diameter parallel plates of the rheometer, and compressing until the edges of the sample were uniform with the edges of the top and bottom plates. The furnace doors that surround the parallel plates and shafts of the rheometer were shut and the temperature was equilibrated at 20° C. and held for 1 minute. The temperature was then ramped from 20° C. to 125 or 130° C. at 3° C./min while the parallel plates were oscillated at an angular frequency of 1 Hertz and a constant strain of 5 percent.

### Hydraulic Shear

The surface of a Goodrich P215 (Goodrich Corporation, Akron, Ohio) tire was applied with 300 ft-lbs of pressure using a hydraulic jack to a 2 in.×2 in. sample adhered to a concrete paver. The tire was rotated 180° four times using an articulating torque bar. After the rotations were complete the sample was removed and visually inspected. Results are reported relative to CE1, wherein a 1 rating is better performance than CE1, 2 is equivalent to CE1, and a 3 rating is worse performance relative than CEL1.

### Cold Shock

Samples (2 in.×2 in.) adhered to a concrete paver are equilibrated at −20° C. temperature. While at such cold temperature, a sharpened screwdriver is applied to the edge of the marking and the sample-paver interface is struck with a hammer. Results are reported relative to CE1, wherein a 1 rating is better performance than CE1, 2 is equivalent to CE1, and a 3 rating is worse performance relative than CE1. Examples were rated based on delamination of the backing from the concrete paver. Examples with more backing retained on the paver than the control were rated as better (1). Examples showing more wear or removal of the backing from the paver than the control were rated as worse (3).

### Environmental Cyclic Aging

Samples (2 in.×2 in.) adhered to a concrete paver were placed in a THERMOTRON (Thermotron Industries, Holland, MI) environmental chamber #E45-2 with the sequence 1 to 4 below, wherein the sequence repeated steps 1 to 4 for a total of 72 hours. 95% humidity was turned off at step 3 and turned back on during ramp 1 when the temperature exceeded 21° C. When cooling, the humidity controller is turned off.
1. 2-hour ramp to 60° C.
2. 2-hour soak at 60° C.
3. 2-hour ramp to −20° C.
4. 2-hour soak at −20° C.

### Preparatory Example

### Synthesis of Preparatory Example 1 (PE1)

Methyl methacrylate (11 grams) was combined with butyl acrylate (39 grams) in a 200 mL glass jar equipped with a stir bar. Ethyl acetate (100 grams), IOTG (0.075 grams), and VAZO 67 (0.05 grams) were then added and the solution was purged by bubbling nitrogen through the solution for a period of 5 minutes, and then a lid was placed on the jar. The jar was placed in a water bath set to 70° C. on a stir plate for a period of 24 h. Solvent and residual monomer were removed by a vacuum oven set to 40° C. at a pressure of −30 in Hg.

### EXAMPLES

Examples CE-3 and EX-1 to EX-4 in Table 2 were prepared by combining the listed materials in ajar and rolling for 24 hours prior to coating. Tapes were prepared by pouring the solution onto PET1 then passed under a notch bar coater set with a gap of 24 mil (610 μm). The tape was then placed in a vented oven (Blue M model DC-246AG-HP) set to 70° C. for a period of minutes. Two layers of each tape were laminated together to make a thicker sample.

TABLE 2
Compositions of UV-Activated Tapes for
Investigating the Effect of Polyol Concentration

| | Final | | | | | |
|---|---|---|---|---|---|---|
| | Thickness | LA2330 | 828 | 2200 | 6976 | Toluene |
| Example | (mm) | (wt. %) | (wt. %) | (wt. %) | (wt. %) | (wt. %) |
| CE-3 | 0.36 | 24.8 | 24.8 | 0.0 | 1.0 | 49.5 |
| EX-1 | 0.39 | 24.8 | 19.8 | 5.0 | 1.0 | 49.5 |
| EX-2 | 0.39 | 24.8 | 17.3 | 7.4 | 1.0 | 49.5 |
| EX-3 | 0.39 | 24.8 | 14.9 | 9.9 | 1.0 | 49.5 |
| EX-4 | 0.39 | 24.8 | 12.4 | 12.4 | 1.0 | 49.5 |

Examples EX-5 to EX-11 in Table 3 were prepared using a batch twin screw extruder with the following settings:
Extruder and melt train temperature: 250° F. (121° C.)
Hose and die temperature: 280° F. (138° C.)
Screw speed: 150 rpm

Upon exiting the die, the melt was coated on PET1 liner. The samples were then wound into a roll. Extruded samples were 80-145 μm thick transfer tapes. These tapes were then laminated up to double the thickness to between 160-290 μm.

TABLE 3
Compositions of UV-Activated Tapes Made Using a Batch Twin Screw Extruder

| | Final | | | | | | | | | |
|---|---|---|---|---|---|---|---|---|---|---|
| | Thickness | | | | | | | | | IRG |
| Example | (mm) | LA2330 | LA2140 | 828 | 2200 | 6976 | ENR50 | 4454 | Q3620 | 1010 |
| EX-5 | 200 | 39.0 | 0.0 | 29.3 | 29.3 | 2.0* | 0.0 | 0.0 | 0.0 | 0.5 |
| EX-6 | 250 | 39.0 | 0.0 | 29.3 | 29.3 | 2.0 | 0.0 | 0.0 | 0.0 | 0.5 |
| EX-7 | 180 | 0.0 | 39.0 | 29.3 | 29.3 | 2.0 | 0.0 | 0.0 | 0.0 | 0.5 |
| EX-8 | 200 | 29.3 | 0.0 | 29.3 | 29.3 | 2.0 | 0.0 | 9.8 | 0.0 | 0.5 |
| EX-9 | 160 | 19.5 | 0.0 | 29.3 | 29.3 | 2.0 | 0.0 | 19.5 | 0.0 | 0.5 |
| EX-10 | 290 | 29.3 | 0.0 | 29.3 | 29.3 | 2.0 | 9.8 | 0.0 | 0.0 | 0.5 |
| EX-11 | 250 | 29.3 | 0.0 | 29.3 | 29.3 | 2.0 | 0.0 | 0.0 | 9.8 | 0.5 |

*PI 2074/ITX (1:1) was used instead of CPI 6976

Examples EX-12 to EX-19 in Table 4 were prepared using a 12-zone, continuous hot melt extruder with the average temperature of 250° F. (121° C.) and a screw speed of 500 rpm.

Upon exiting the die, the melt was coated on PET1 liner and then laminated with PET2 liner. The samples were then wound into a roll.

TABLE 4
Compositions of UV-Activated Tapes Made Using a Continuous Twin Screw Extruder

| | Final | | | | | | | | |
|---|---|---|---|---|---|---|---|---|---|
| | Thickness | | | | | | IRG | | |
| Example | (mm) | LA2330 | 828 | 2200 | 6976 | 1001 | 1010 | Q3620 | DUALITE |
| EX-12 | 200 | 29.1 | 29.1 | 29.1 | 1.9 | | 1.0 | 9.7 | 0.0 |
| EX-13 | 250 | 38.8 | 29.1 | 29.1 | 1.9 | | 1.0 | 0.0 | 0.0 |
| EX-14 | 180 | 48.5 | 24.3 | 24.3 | 1.9 | | 1.0 | 0.0 | 0.0 |
| EX-15 | 200 | 34.0 | 29.1 | 29.1 | 1.9 | | 1.0 | 4.9 | 0.0 |
| EX-16 | 160 | 38.5 | 28.8 | 28.8 | 1.9 | | 1.0 | 0.0 | 1.0 |
| EX-17 | 290 | 48.1 | 24.0 | 24.0 | 1.9 | | 1.0 | 0.0 | 1.0 |
| EX-18 | 250 | 33.7 | 28.8 | 28.8 | 1.9 | | 1.0 | 4.8 | 1.0 |
| EX-19 | 210 | 50 | 22 | 8 | 2 | 20 | 1.0 | | |

Examples EX-20 and CE-4 in Table 5 were prepared by combining the listed materials in ajar and rolling for 24 hours prior to coating. Tapes were prepared by pouring the solution onto PET1 then passed under a notch bar coater set with a gap of 24 mil (610 μm). The tape was then placed in a vented oven (Blue M model DC-246AG-HP) set to 70° C. for a period of 5 minutes. Two layers of each tape were laminated together to make a thicker sample.

TABLE 5
Preparation of Tapes for Comparing Random to Block Acrylic Copolymers

| | Final | | | | | | | |
|---|---|---|---|---|---|---|---|---|
| | Thickness | | | | | | | |
| Example | (mm) | LA2330 | PE1 | 828 | 4013F | ITX | 250 | Q3620 |
| EX-20 | 200 | 34.0 | 0.0 | 29.1 | 29.1 | 1.0 | 1.9 | 4.9 |
| CE-4 | 250 | 0.0 | 34.0 | 29.1 | 29.1 | 1.0 | 1.9 | 4.9 |

TABLE 6
Adhesion Properties of UV-Activated Tapes

| | 90° Peel | | | | | Tensile | Gel |
|---|---|---|---|---|---|---|---|
| | Adhesion | | Static | Dynamic | Push Out | Impact | Content |
| | (lbs/in width) | | Shear | Shear | Strength | Strength | (% Wt. |
| Example | Uncured | Cured | (min) | (N/mm) | (N) | (J) | Loss) |
| CE-1 | | | 3100 | 1.18 | 168 | 1.01 | |
| CE-2 | | | >10,000 | 1.25 | 274 | 0.37 | |
| CE-3 | | | | | | | 93 |
| EX-1 | | | >10,000 | | 819 | | 83 |
| EX-2 | | | >10,000 | | 865 | | 74 |
| EX-3 | | | >10,000 | | 709 | | 66 |
| EX-4 | | | >10,000 | | 585 | | 50 |
| EX-5 | | | >10,000 | | 109 | | |
| EX-6 | | | >10,000 | 1.91 | 465 | 0.83 | |
| EX-7 | | | >10,000 | 2.14 | 577 | 1.24 | |
| EX-8 | | | >10,000 | 2.12 | 382 | 1.27 | |
| EX-9 | | | >10,000 | 0.54 | 73 | 1.09 | |
| EX-10 | | | >10,000 | 2.94 | 201 | 0.87 | |
| EX-11 | | | >10,000 | 3.09 | 667 | 1.80 | |
| EX-12 | 1.24 | 9.32 | >10,000 | 2.03 | 239 | 1.16 | |
| EX-13 | 3.79 | 11.13 | >10,000 | 2.00 | 231 | 0.68 | |
| EX-14 | 5.11 | 10.54 | >10,000 | 1.28 | 138 | 0.51 | |
| EX-15 | 1.78 | 9.33 | >10,000 | 1.91 | 271 | 1.05 | |
| EX-16 | 2.82 | 8.85 | >10,000 | 2.33 | 138 | 0.55 | |
| EX-17 | 7.29 | 10.07 | >10,000 | 2.88 | 233 | 0.58 | |
| EX-18 | 2.05 | 9.12 | >10,000 | 2.47 | 271 | 0.99 | |
| EX-19 | 3.39 | | >10,000 | 7.32 | 1041 | 0.194 | |
| EX-20 | | | >10,000 | 0.97 | 318 | 0.46 | |
| CE-4 | | | 0 | 0.15 | 50 | 0.45 | |

TABLE 7
Tensile DMA Rheology Data for Select UV-Activated Tapes

| | Cured E′ at 23° C. | Cured Tan(δ) max |
|---|---|---|
| Example | (pa) | (° C.) |
| CE-3 | 4.50E+08 | 128 |
| EX-1 | 4.75E+08 | 81 |
| EX-2 | 3.37E+08 | 57 |
| EX-3 | 8.32E+07 | 40 |
| EX-4 | 6.17E+06 | 21 |
| EX-12 | 3.70E+06 | 14 |
| EX-13 | 2.93E+06 | 19 |
| EX-14 | 2.60E+06 | 30 |
| EX-15 | 3.67E+06 | 17 |

Epoxidized natural rubber ENR50 solutions were prepared by masticating the ENR50 with an extruder with a screw rate of 400 rpm for 4 minutes and then dissolving in toluene to obtain a 35 wt. solution. The ENR5 solution was combined with 828, D1119, and curing catalyst as shown in Table 8. The materials were coated at a 12 mil wet gap onto the silicone surface of PET1 liner using a notch bar and dried at 74° C. (165° F.) for a period of 9 minutes. After drying the silicone surface of PET1 liner was laminated to make an adhesive transfer tape.

TABLE 8
Curable Adhesive Tapes with Epoxidized Natural Rubber,
Styrenic Block Copolymer, and Epoxy Resin

| | | | | | | Uncured | Cured |
|---|---|---|---|---|---|---|---|
| | | | | | | Peel | Peel |
| Example | ENR50 | 828 | D1119 | OMICURE | 6976 | (N/cm) | (N/cm) |
| EX-21 | 50 | 8.75 | 0.0 | 4.3 | 0.0 | 1.67 | 40.3 |
| EX-22 | 107 | 50 | 0.0 | 0.0 | 0.5 | 4.72 | 29.7 |
| EX-23 | 35.71 | 50 | 37.5 | 7 | 0.0 | 0.04 | 20.0 |
| EX-24 | 71.43 | 50 | 25 | 7 | 0.0 | 2.91 | 33.7 |
| EX-25 | 107.14 | 50 | 12.5 | 7 | 0.0 | 5.28 | 36.4 |

The adhesive compositions of Examples 1-24 can be utilized for the articles and method described herein.

TABLE 9
Compositions of UV-Activated Tapes

| Example | LA2330 | 1001 | 828 | 2200 | Q3620 | 6976 |
|---|---|---|---|---|---|---|
| EX26 | 55 | 15 | 15 | 15 | 0 | 2 |
| EX27 | 50 | 10 | 22.5 | 12.5 | 5 | 2 |
| EX28 | 50 | 10 | 17.5 | 17.5 | 5 | 2 |

Sample compositions described in Table 9 were compounded and extruded through the hot melt extruder. Upon exiting the die, the melt was coated on PET 1 and then laminated with PET 2. The samples were then wound into a roll. Sheets were laminated to a width of 0.016 inches (400 μm) then heat laminated to Retroreflective Sheet Material 1. The samples were then irradiated using an OMNICURE AC7300 UV-LED (Excelitas Technologies Corp., Waltham, MA) mounted on an OMNICURE CV300 conveyor and given a total exposure of 4 J/cm² UVA, as measured by a (Power Puck II radiometer (EIT, LLC, Leesburg, VA), then immediately applied to a concrete paver (Pavestone 12 inch×12 inch X1.5 inch Pewter Square Concrete Step Stone, 71200, obtained from Home Depot) which was preheated to 45° C. A force of 400 lbs was applied for thirty seconds using a Carver press. The samples were then left to cure for 72 hours before testing. In the case when a primer was used, the primer was painted on to the surface of the paver and allowed to dry. The sample was then applied to the primed surface of the paver.

Example 29 was prepared by heat laminating the transfer tape of example 28 onto Retroreflective Sheet Material 2 then applying that construction to the concrete paver using a carver press with a force of 400 lbs for 30 seconds.

Samples adhered to the concrete paver were tested using the Hydraulic Shear, Cold Shock, and Environmental Cyclic Aging test methods. Results for Hydraulic Shear and Cold Shock are rated relative to the control PSA1. The results are reported in Tables 10 and 11. All samples showed no delamination after the Environmental Cyclic Aging test. Examples were rated based on delamination of the backing from the concrete paver. Examples with more backing retained on the paver than the control were rated as better (1). Examples showing more wear or removal of the backing from the paver than the control were rated as worse (3).

TABLE 10
Hydraulic Shear Test Results

| Example | Rating |
|---|---|
| EX26 | 2 |
| EX27 | 1 |
| EX28 | 1 |
| Primed EX28 | 1 |
| EX29 | 3 |
| PSA 1 | 2 |

TABLE 11
Cold Shock Test Results

| Example | Rating |
|---|---|
| EX30 | 2 |
| EX32 | 2 |
| Primed EX32 | 2 |
| EX33 | 1 |
| PSA 1 | 2 |

TABLE 12
Shear Rheology Data for Select Tapes (i.e. initial adhesion)

| | Example 33 Uncured | Example 33 Cured | PSA1 |
|---|---|---|---|
| Temperature | Modulus | Modulus | Modulus |
| (° C.) | (G′, MPa) | (G′, MPa) | (G′, MPa) |
| 5 | 0.8 | 13.7 | 0.1 |
| 23 | 0.2 | 9.8 | 0.05 |
| 70 | 0.05 | 0.2 | 0.03 |

1. An adhesive article comprising:
a layer of a curable adhesive composition that comprises:
20 wt. % to 60 wt. % of an acrylic block copolymer;
5 wt. % to 60 wt. % of an epoxy resin; and
1 wt. % to 60 wt. % of a polyol; and
inorganic particles disposed on a major surface of the article.

2. The adhesive article of claim 1 wherein the inorganic particles are selected from reflective particles, traction particles, and combinations thereof.

3. The adhesive article of claim 1 wherein the reflective particles are reflective pigment particles or retroreflective elements selected from a) glass or ceramic beads or b) a core particle comprising the beads at least partially embedded in a core.

4. The adhesive article of claim 1 wherein the inorganic particles are at least partially embedded in the curable adhesive composition.

5. The adhesive article of claim 1 wherein the inorganic particles are at least partially embedded in a binder disposed on the major surface of the article.

6. The adhesive article of claim 1 further comprising a backing disposed within the curable adhesive layer or between the binder and the curable adhesive layer.

7. The adhesive article of claim 6 wherein the backing comprises a scrim, acrylonitrile rubber, or a combination thereof.

8. The adhesive article of claim 1 wherein the article is a pavement marking tape.

9. The article of claim 1 wherein the acrylic block copolymer comprises 7 wt. % to 51 wt. % of a hard block and 49 wt. % to 93 wt. % of a soft block.

10. The article of claim 9 wherein the hard block comprises polymethyl methacrylate.

11. The article of claim 9 wherein the soft block comprises polybutyl acrylate.

12. The article of claim 1 wherein the epoxy resin has an epoxy equivalent weight of from 150 to 250.

13. The article of claim 1 wherein the epoxy resin comprises a first epoxy resin and a second epoxy resin combined in a ratio of 0.5:1.5, optionally 0.75:1.25, or optionally 1:1.

14. The article of claim 13 wherein a second epoxy resin has an epoxy equivalent weight of from about 500 to about 600.

15. The curable composition of claim 1 wherein the epoxy resin comprises a bisphenol A derived epoxy resin.

16. The curable composition of claim 1 wherein the polyol has a molecular weight of 500 g/mol to 14,000 g/mol.

17. The curable composition of claim 1 wherein the polyol comprises a polyether polyol, a polyester polyol, and combinations thereof.

18. The curable composition of claim 1 further comprising a curing agent selected from the group consisting of an amine curing agent, a photoinitiator, a photoacid, and combinations thereof.

19. The curable composition of claim 18 wherein the curable composition comprises 0.5 wt. % to 10 wt. % of curing agent(s).

20. An adhesive article comprising:
a layer of a curable adhesive composition that comprises:
20 wt. % to 60 wt. % of a thermoplastic block copolymer having a molecular weight of at least 30,000 g/mole;
5 wt. % to 60 wt. % of an epoxy resin; and
1 wt. % to 60 wt. % of a polyol; and
inorganic particles disposed on a major surface of the article.

21-26. (canceled)
